(19) United States
(12) Patent Application Publication
(10) Pub. No.: US 2007/0282697 A1
(43) Pub. Date: Dec. 6, 2007

(54) Enhancing commerce

(76) Inventor: Alan Kirby, Hollis, NH (US)

Correspondence Address: FISH & RICHARDSON PC, P.O. BOX 1022, MINNEAPOLIS, MN, 55440-1022, US

(21) Appl. No.: 11/444,618

(22) Filed: Jun. 1, 2006

(51) Int. Cl. G06Q 30/00

(52) U.S. Cl. 705/26

(57) ABSTRACT

Among other things, a giver is enabled to buy a gift online for a recipient and to control the provision of a puzzle for the recipient to solve before the gift is to be delivered, and the gift is caused to be delivered only under circumstances related to the solving of the puzzle.

### BACKGROUND

This description relates to enhancing commerce.

In the World Wide Web, for example, commerce at a retail site is sometimes enhanced using simple hyperlinks or advertisements that refer buyers from other websites to the retail site. In another approach, a search engine may be paid to return search “hits” that favor the retail site. When the retail site can identify the source of referral of a transaction that occurs on the retail site, compensation may be paid for the referral.

### SUMMARY

In general, in an aspect, in response to information provided electronically by a first user, a second user is enabled to engage at least partly electronically in an interactive activity that is based on the information provided by the first user, a determination is made that the second user has engaged in the interactive activity, and an item such as a product or service of interest (which has been paid for at least partially by the first user) is provided to the second user.

Implementations may include one or more of the following. Providing the item includes delivering the item. The item is obtained by online interaction with an online entity. In some examples, the item is received from the first user. At least one of the steps of the delivery to the second user occurs before determining that the second user has engaged in the interactive activity. Providing the item includes informing the second user that the item is available for pick-up at a location. Identifications of the first user and the second user are received from a seller of the item. Identification of the interactive activity is received from the first user. Identification of the interactive activity is received from a plurality of first users. A data file which defines the interactive activity is received from the first user. Instructions to automatically select the interactive activity are received from the first user. Identification of a date when the second user should be enabled to engage in the interactive activity is received from the first user.

The enabling of the second user to engage in the interactive activity is facilitated by a seller of the item. The providing includes delivery of the item by a shipper to the second user and the enabling of the second user to engage in the interactive activity is done by the shipper. The first user is enabled to control selection of the item. The item is delivered to the shipper with instructions, for example, not to deliver the item until a condition is met. The condition may be that the second user has engaged in the interactive activity. The second user is informed that the interactive activity is available.

In some examples, the user is enabled to download the item or to use the item. Advertising is presented to the second user. At least one of the following is done: providing a URL to the second user, serving a web page to the second user, downloading software to the second user, receiving information from the second user, and presenting to the second user one or more of a user interface of the interactive activity, advertisements, an identification of a seller of the item, an identification of a shipper, decorations selected by a seller of the item, and decorations selected by a shipper of items.

The advertisements presented to the second user may advertise one or more of the following: accessories for the item, upgrades to the item, services related to the item, and additional items complementary to the item. The decorations comprise trade dress of the seller or the shipper. The information received from the second user includes proof that the second user has paid a sum of money. The item may be one or more of a tangible asset, a negotiable instrument, an electronic equivalent of a negotiable instrument, a privilege, the right to use a service, an item of value, information, an identification of a location of another item of interest, and data.

The interactive experience includes one or more of a puzzle, a crossword puzzle, a sudoku puzzle, a word-search puzzle, an electronic representation of a board game, a quiz, a game, a trivia game, a scavenger hunt, and a series of interactive experiences.

The first user is enabled to select one or more of a type of interactive activity from a set of types of interactive activities, a specific interactive activity from a set of specific interactive activities, a difficulty, and a theme. The first user is enabled to control one or more of a theme, information to be used in the interactive activity, problems to be posed by the interactivity, solutions to problems to be posed by the interactivity, and data representing the interactivity. The first user may cause the interactive activity to be custom designed. Enabling the second user includes one or more of presenting the interactive experience to the second user, receiving input from the second user, updating the state of the interactive experience, evaluating whether the input is responsive to the interactive experience, and determining that the second user has completed the interactive experience.

In an aspect, in general, a system includes one or more computers configured to allow a first user to purchase an item, provide a first user interface to allow the first user to select an interactive activity, provide a second user interface to allow a second user to engage in the interactive activity, determine that the second user has completed participating in the interactive activity, and cause the delivery of the item when the second user has completed participating.

In an aspect, in general, an item of value is received (e.g., by a shipper) to be delivered to a recipient, and in response to a confirmation that a puzzle has been solved at least in part by the recipient, the item is delivered to the recipient.

In an aspect, in general, a giver is enabled to buy a gift online for a recipient and to control the provision of a puzzle for the recipient to solve before the gift is to be delivered, and the gift is caused to be delivered only under circumstances related to the solving of the puzzle.

In an aspect, in general, a package includes packaging, a gift inside the packaging, and a label identifying the package as one not to be delivered to a recipient until a shipper of the package has received confirmation that a game associated with delivery has been solved by the recipient.

Other aspects may include other combinations of these and other aspects and features and may be expressed as methods, apparatus, systems, program products, and in other ways.

Other features and advantages will be apparent from the description and from the claims.

### DESCRIPTION

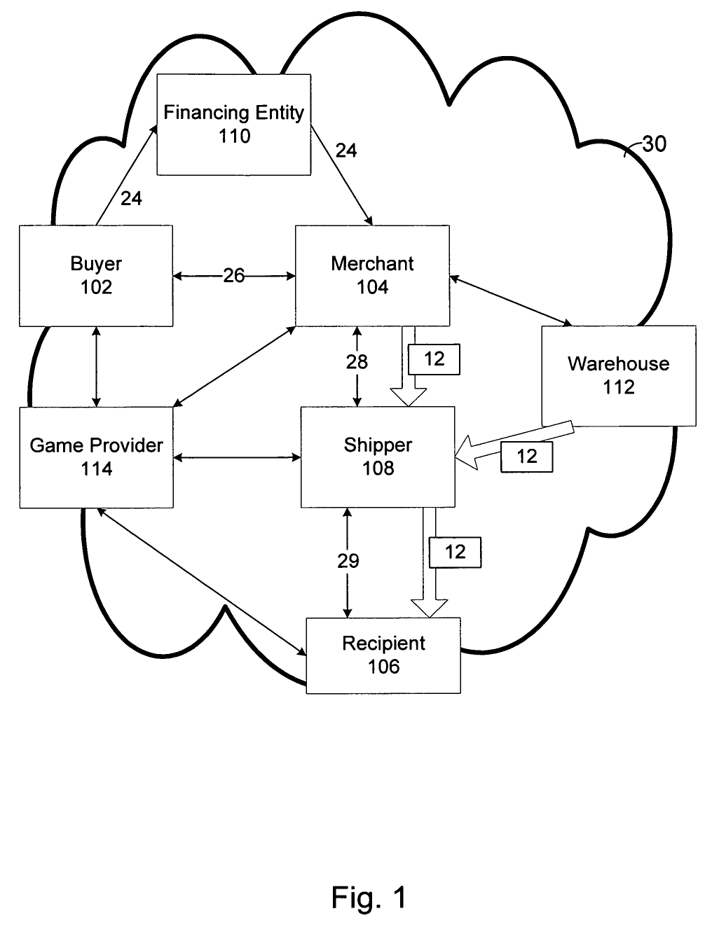

FIG. 1 is a block diagram.

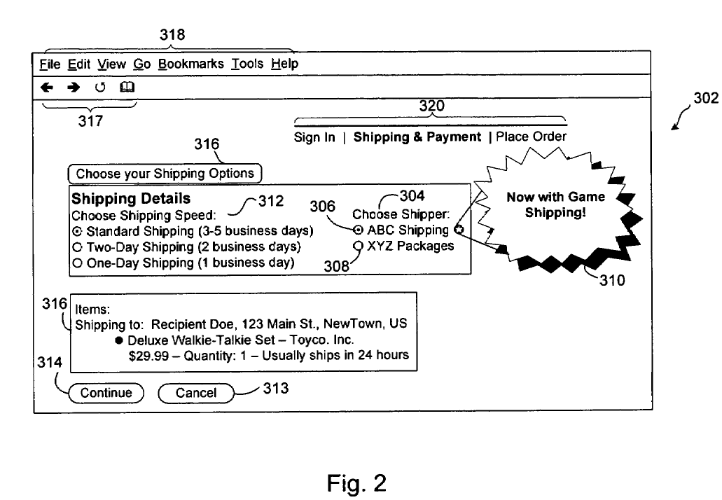

FIGS. 2, 3, 4A-D, and 5A-B are screenshots.

As shown in FIG. 1, in a common model of electronic commerce, an electronically accessible entity 104 may derive revenue from a transaction in which a product or other item or service of value or of other interest 12 (we sometimes use only the word value or only the word interest to refer to either or both attributes) is provided to a recipient 106 and paid for by a customer 102. In some cases, the product or service may be delivered by a delivering entity 108 from a repository 112 instead of directly from the entity 104 to the recipient 106. Sometimes a financing entity 110 provides the funds 24 that are paid to the entity 104 on behalf of the customer 102 and collects the funds from the customer 102. A wide variety of other entities (not shown) also may be involved in facilitating, managing, and recording the transaction.

Many of the communications among the entities in FIG. 1 that are needed to facilitate the transactions may occur through a publicly accessible network such as the Internet 30 or through dial up or trunk connections, through wired or wireless connections, or through non-electronic communications. A wide variety of kinds of communication can occur to facilitate the transactions, among others, order interaction 26 between the customer and the entity 104, delivery interaction 28 between the entity 104 and the delivering entity 108, and order and delivery confirmation interaction 29 between the delivering entity 108 and the recipient 106. Other interactions may occur that are not shown in FIG. 1. In FIG. 1, communication is shown by solid arrows, and the movement of goods or services is shown with open arrows.

The entity 104 may be a person, a group of people, a retailer, a wholesaler, a service provider, a governmental agency, a non-profit organization, or any other entity that derives revenue from electronic transactions. For simplicity and without in any way limiting the breadth of the term entity, we refer to the entity 104 sometimes as a retailer or merchant.

The customer 102 may be a person, a group of people, a company, a service user, a governmental agency, a non-profit organization, or any other entity that is arranging for a product or service to be provided to the recipient. The recipient 106 may be a person, a group of people, or any other entity to which an product or service can be provided. The delivering entity 108 may be a shipper of physical goods, an entity that delivers ephemeral products or services, or any other entity that provides the goods or services to the recipients. The repository 112 may be a warehouse or other storage facility in which goods are stored while awaiting delivery or any other entity in which either physical or ephemeral goods or services (for example products in electronic form) are held pending delivery to the recipient.

In some examples discussed here, the customer is someone who wants to send a physical good, for example, a toy or an electronic device, as a gift to the recipient and the entity 104 is an on-line merchant that sells the good to the gift sender in a credit card transaction and authorizes a shipper to deliver the good to the recipient. To simplify the description of the examples, we sometimes refer to the customer as a buyer or giver, the entity 104 as a merchant or retailer, the financing entity as a credit card company, the delivering entity as a shipper, the repository as a warehouse, and the goods or services as a gift. Our use of these terms is not meant to limit in any way the full breadth of the terms of which they are merely examples.

An interaction facilitating entity 114 can provide a medium for interaction between the giver and the recipient of the gift in a way that can increase electronic commerce of the entity, the shipper, the credit card company, or other parties that are involved in some way in the transaction. In some examples described here, the interaction facilitating entity enables the giver and the recipient to interact through the medium of a game or puzzle, and a wide variety of other interaction devices are also possible. The delivery of the gift to the recipient may be conditioned (strictly or for a period of time or in some other way) on a successful conclusion of the puzzle or game. The delivery may be conditioned on a wide variety of other interactions that involve the giver and the recipient, but for simplicity (and without limitation) we sometimes refer to the interaction facilitating entity as a puzzle provider and the interaction medium as a puzzle or a game.

In some examples, the giver has a role in selecting or creating the puzzle and the puzzle may include some aspects that are associated specifically with the giver, the recipient or both. In those and some other examples, a feature of the interaction medium is meant to enhance the gift giving and gift receiving experience by encouraging some degree of interaction or awareness of the other party's role in selecting, giving, receiving, or solving the gift or the puzzle. Thus any kind of interaction that achieves that result is intended to fall within the activities of the interaction facilitating entity and the game.

By enhancing the gift-giving experience, more transactions are expected to occur and the commerce experienced by one or more of the merchant, the recipient, the delivering entity, the financing entity, or other entities involved in the transaction. The resulting additional revenue may be shared with the party that hosts the interaction facilitating entity 114. For that purpose, the puzzle provider could have a presence on the web site of the cooperating entity, either branded in the name of the puzzle provider or private labeled in the name of the merchant. In some examples, the puzzle provider would have its own presence on the World Wide Web.

Although FIG. 1 suggests that the entities shown there are independent entities, in fact, one or more groups of two or more of the entities may be combined as single entities. For example, the retailer may own or control the shipper. Or the shipper may own the warehouse.

In the system illustrated in FIG. 1, gift givers can enhance the enjoyment of the gift giving process by having a puzzle presented to the recipient prior to the delivery of the gift. The merchant may enhance the value of its products, and its revenue, by providing a greater variety of options in the shipping of the products. And the shipper may enhance their appeal either to the merchant or to the giver, in order to increase the number of shipments and the revenue that can be realized from those shipments. A wide variety of other modes are also possible in which to enhance the offerings of one or more of the entities shown in FIG. 1.

In some implementations, the puzzle feature is offered by the shipper 108 through the merchant 104 to the giver as an option associated with the shipper's usual services. In some examples, the recipient 106 must complete the puzzle before the gift is delivered or before some other step associated with the delivery of the gift occurs. When the giver 102 selects a product to purchase and identifies to the merchant 104 that it is a gift, the shipper 106's game service (we sometimes refer to the puzzle service as a game service) is offered to the buyer (see FIG. 2). If the buyer 102 selects the game service, he is presented with additional choices, such as the type of game and its difficulty. The buyer (we sometimes refer to the giver as the buyer) 102 may be able to customize the game, for example, by providing trivia information (e.g., questions and/or answers) that the recipient might appreciate or be able to answer. The gift itself may be provided to the shipper 108 directly by the seller 104 (we sometimes refer to the merchant as the seller), or the shipper 108 may pick it up from a warehouse 112. The merchant or the shipper 108 or the sender or a third party informs the recipient 106 that the buyer 102 has sent him a gift, and explains that the recipient needs to complete the game in order to receive the gift. The recipient 106 may complete the game using a web page provided by the shipper. Once completed, the gift is delivered. Each of these steps is explained in more detail below.

The party that offers and provides the game service and the parties that are involved in the game service may vary. In some examples, the seller 104 of products provides the game, determines when the game has been solved or completed, and releases products to the shipper 108 when the game is completed; the shipper 108 has no role in managing the completion of the game. The seller 104 may provide the product to the shipper 108 to begin delivery to the recipient 106 with instructions not to complete delivery until the seller 104 confirms to the shipper 108 that the game has been completed. In such examples, the game may be provided by the seller 104 without requiring the use of a particular shipper 108.

In some examples, a particular shipper 108 provides the game with the seller 104's cooperation to market it to buyers 102 in connection with the shipper's delivery services. This would enable the shipper 108 to use the availability of the game as a competitive advantage over other shipping companies.

In some examples, the game is provided by a third party game provider 114 through arrangements with one or more of the buyer 102, the seller 104, and the shipper 108. The game provider 114 could present the game as its own service marketed directly to the buyer 102. In such a case, the buyer can select the gift from options offered by the game provider 114, either through its own purchasing channels or in cooperation with one or more sellers 104.

The gift could simply be an amount of money provided by the buyer, and the recipient could spend the money on choices from a selection of products or gift certificates from different vendors once he completes the game. Or, the game provider could offer a variety of shipping options which it then engages as would any other seller.

Or the game provider may have arrangements with a particular shipper 108 to promote or exclusively use that company 114 for delivering the gifts. In some examples, the game provider 114 provides the game as a service to the shipper 108 or seller 104 to re-package and offer as its own value-enhancing service. The game could be hosted on the computers of the game provider 114, or the game provider 114 could provide the required data, software, or hardware to the shipper 108 or seller 104 to integrate into its existing systems.

In some examples, the gift is intangible, such as a music recording, computer game, or access to a paid website. In such a case, the shipper 108 is not needed, and the gift can be delivered electronically by the seller 104 or game provider 114. In some examples, the game could be integrated into an electronically delivered gift, for example, a music file is transmitted to the recipient but is not playable until an included game is completed. The gift could also be money, in the form of a promotion code, gift certificate code, access to a line of credit or a debit account, or other instrument. Financial institutions might offer a game option as an enhancement to the gift cards they sell. In general, in this description, references to gifts being delivered include the transmission of data comprising or otherwise relating to the gift, as well as the physical transport of tangible goods.

The game can take many forms. In some examples, it is a typical puzzle such as a crossword, sudoku, quiz, word-search, riddle, anagram, cipher, syllogism, math puzzle, or the like. Such a puzzle can be presented to the recipient 106 on a web site hosted by whichever party is providing the game. More complicated games might require the recipient to locate information from the Internet, from the real world, or from other people. For example, if the buyer wanted to encourage the recipient to learn something about her family history, the game may require the recipient to answer questions about her grandparents. This could include the buyer providing a password to the grandparents, which the recipient needs to provide to prove that she actually talked to them.

Another option could require the recipient to go to a particular place to discover the answer to a question. The complexity of the game may depend on the buyer 102's interest in configuring options and providing information and the game provider 114's interest in providing the systems necessary to provide games with a given level of complexity. In some examples, a multi-stage game may require that the recipient complete a series of tasks in order, with the results of one task necessary to be given or to complete a subsequent task. Game-play may also be tied to the value of the gift, for example, if the recipient completes the game with a certain proficiency or within a certain time, he receives a more valuable version of the gift.

In some examples, the availability of the game is communicated to the recipient by email, and the game is completed at least partially on-line, through a web page. The email and web page providing the game offer an opportunity for any or all of the game provider 114, the seller 104, and the shipper 108 to promote themselves to the recipient 106. This could include branding, advertisements, product placement in the game itself, and the overall look and feel of the interface. For example, if the game is provided by the shipper, and the shipper maintains a consistent trade dress in its products and services, that trade dress could be used in the design of the game. The buyer might specify when the recipient is to be informed of the availability of the game, for example, he might arrange for the game in advance of the recipient's birthday, but want the message about it to be delivered on the birthday.

Depending on the nature of the gift, the seller could offer upgrades, accessories, or additional services. One option may be the time when, during the course of his interaction with the game, the recipient is informed of the identity of the gift. If the nature of the gift is not to be revealed until the game is completed, any advertising could be limited to avoid giving away the surprise. The buyer could be dissatisfied if the recipient were given ads for music player accessories before it was revealed that he had been given a music player, for example. Alternatively, the advertising and other information could be selected to build anticipation, giving hints as to what the gift is as the recipient progresses through the game.

There are advantages for a shipper to provide such a game service, either directly or by contracting with a game provider. If the shipper is the only shipping company offering the service, or offering a particular game, this gives it an additional product it can offer to buyers and sellers, an ability to charge premium rates, and, through the increased desirability of its services, leverage in negotiating rates and other terms with sellers. For example, a shipper may want a more prominent position within a seller's on-line store, listed before its competitors or highlighted relative to them, when shipping options are presented. By providing the seller with a share of the increased revenue resulting in sales of the game service, or simply offering the prospect of increased sales resulting from its availability, the shipper can entice the seller to provide the desired positioning.

Beyond the marketing opportunities provided by the game, the shipper can integrate the game into its delivery system. For example, if a shipper knows that a particularly complicated game generally takes recipients one week to complete, it could hold the shipped gift at an intermediate storage facility rather than transporting it immediately to its destination and having it take up space on a delivery truck while awaiting completion of the game. In a game having multiple stages, completion of the stages can be used to more finely tune the flow of the package through the delivery system. With sufficient information, a shipper could optimize its shipping process to deliver the game the same day it is solved, enhancing its reputation with both the buyer and recipient and reducing its warehouse and shipping costs. If the storage necessary due to completion time of the game represents a cost rather than a benefit to the shipper, that can be compensated for in the price charged for the game service.

An example interface for a shipper offering the game is shown in FIG. 2. In a shipping options screen 302, a buyer has selected a gift and payment method and is presented with a list 304 of shippers 306, 308. One shipper 306, ABC Shipping, offers the game option, and has negotiated with the seller both to list shipper ABC first and to separately promote the game option. To promote this, a callout 310 identifies ABC Shipping as offering the option. User interface elements 312-320 are those commonly found in an e-commerce interface. Once the buyer has selected the game shipping option and clicked “continue,” he proceeds to the game selection screens, described below.

In some examples, the shipper offers the service directly through its own sales outlets (e.g., on-line or real world stores) for gift givers who already have the gifts in their possession or otherwise want to send them themselves. The sender can use the interface provided by the shipper to configure the game and print a shipping label and then turn the gift over to the shipper for handling. The shipping label identifies that the package is controlled by the game system, so the shipper will handle it appropriately and not deliver it until the game is completed or some other authorization is provided to the shipper to proceed with delivery.

There are also advantages for the seller either to provide a game service of its own or to partner with a game provider and shipper to do so. In addition to attracting additional customers and directly bringing in revenue (assuming the retailer charges for the service), being a part of the game delivery process allows the retailer to get in on the advertising opportunities discussed above. In some examples, the advertising revenue or increased overall sales may be enough to compensate for the cost of providing the game, allowing the seller or shipper to offer the game for free, further increasing usage of the game service and enlarging the audience of the associated advertisements.

Third parties may also be involved in cooperation with any or all of the parties already identified. For example, whichever party is providing the game could sell advertising opportunities to third parties or allow third parties to offer enhanced versions of games. If the seller is a book retailer, a publisher may want to offer a particular game based on a book it sells through the retailer in order to promote a movie based on the book or to enhance and extend the marketing associated with the book. In some examples, an on-line service provider (email service, web hosting company, etc.) could host the game in exchange for an opportunity to market itself to the recipient.

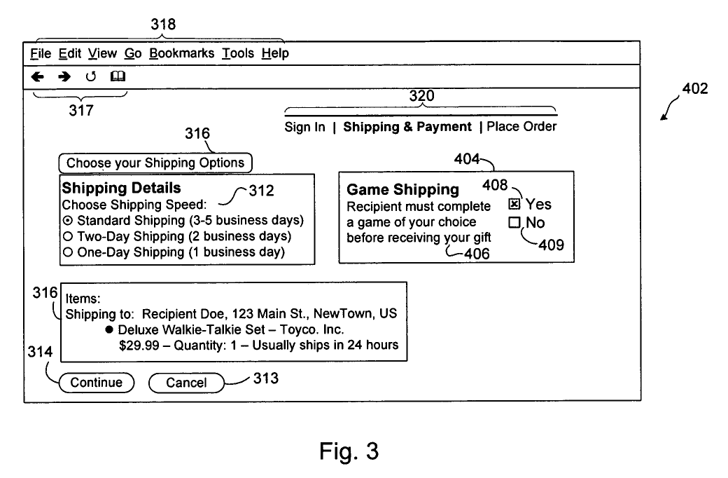

An example interface for a seller offering the game is shown in FIG. 3. It is similar to that shown in FIG. 2, but the game is offered independently of the shipper. A special box 404 on a shipping option screen 402 offers the game option to the buyer, including a description 406 and selection boxes 408, 409 for the buyer to select or decline the option. Details about how this box is presented will depend on numerous considerations, such as the sophistication of potential buyers, whether they are expected already to be familiar with the game option, and who is involved in offering the game option. A shipper could negotiate with a seller to be the only shipper to provide the game, even if the shipper isn't itself involved in providing it. In such a case, the interface may appear like that shown in FIG. 2, or it may remain like that in FIG. 3 but indicate in box 404 which shipper is involved (e.g., the box could be titled “ABC Shipping's Game Shipping”).

For each of these scenarios, the third-party game provider can be involved at any level of detail. A full service game provider could handle all aspects of the interaction, hosting all the required user interfaces for creating and completing the game, directing the movement of the gift from seller to shipper to delivery, and handling all communications among the buyer, seller, shipper, and recipient. A game provider could provide any subset of those services, for example, providing the game interface to the seller to host on its own computer systems and not interacting with the shipper at all. The game provider could interact with the shipper simply as a proxy for the seller, giving the final order to deliver the package when a game it hosts is completed.

In some examples, a game provider could develop a game service with a shipper and then market that service to sellers on behalf of the shipper. The game provider would handle the interaction between the seller and the shipper and the interaction with the recipient, allowing the seller to provide the gift to the shipper as usual, and then coordinate with the shipper to deliver the gift when the puzzle is completed. Such a game provider could employ interface designers and game designers to design and deliver the games and the related interfaces and business developers and marketing experts to market the service to the other parties and coordinate the interaction between the game and interface developers and the customers (shippers, sellers, buyers). Depending on the scope of its interaction with the seller or shipper, the game provider could be compensated by a percentage of incremental revenue, a fee for services rendered, a flat fee, or other arrangements.

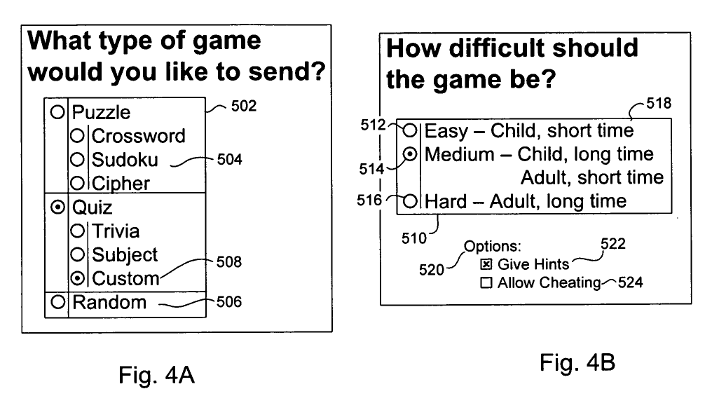

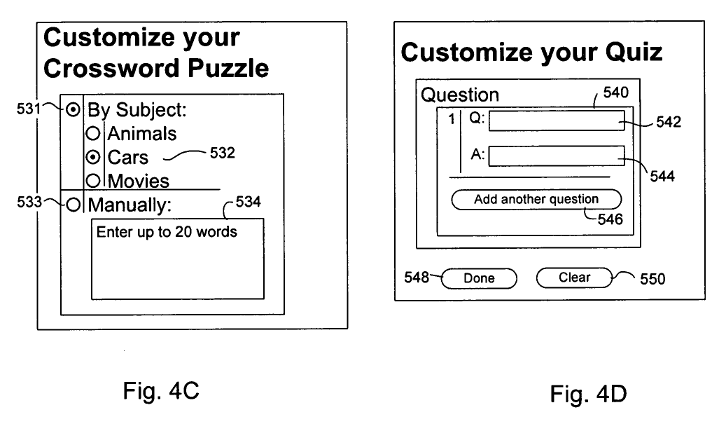

Once the buyer has chosen to use the game option, she is presented with a user interface like that shown in FIGS. 4A-4D. This interface will generally be the same regardless of which party is actually providing the game. As a first step, as shown in FIG. 4A, the buyer selects which sort of game she wishes to use from a list 502 of available games. A set 504 of defaults may be provided, so that a buyer who doesn't want to spend any additional time selecting details isn't required to do so. One of the options 506 may also be for the system to randomly select a game. Having default options 504 can be important to avoid losing a sale to a buyer who may select the game option when choosing her shipping mode, but give up on the purchase entirely if burdened with more questions than she was expecting after she thought she had made her purchase and was finished. Other options may be to customize (508) the game. The desirability of the game system to a retailer or a shipper as a mode of attracting additional business may also depend on assuring that customers of the shipper or retailer will not be burdened, confused, or delayed by the process of applying a game to a purchase.

If the buyer selects a non-customized game, she might be presented with only simple options such as type of game and how difficult to make it, as shown in FIG. 4B. In this example, difficulty choices 510 are described as easy (512), medium (514), and hard (516) The age of the recipient and how long it should take her to complete the game (518) are listed to explain the levels. Other ways to define difficulty may be by comparison to other recognizable measures of difficulty, such as a well-known puzzle or game. The game provider could keep track of past purchases, and offer to give a recipient a game harder or easier than the last one he completed. Other options 520 may be offered, for example for the game to give hints (522) or to allow the recipient to cheat (524), if (cheating is possible in the game selected).

If a buyer wishes to customize a puzzle, a wide range of options might be available, as shown in FIGS. 4C and 4D. At a simple level, a customization interface 530 provides a choice 531 to select a subject for a pre-existing puzzle from list of keywords 532. A more advanced option 533 may allow the buyer to manually provide a set of words 534 to be used in creating the puzzle. At a higher level of complexity, as in the example of FIG. 4D, an interface 540 lets the buyer provide questions 542 and answers 544 to be used in creating a quiz game. A button 546 allows the buyer to add another question, up to a limit imposed by the system, if any. Other buttons 548, 550 may allow the buyer to indicate that he is finished or to start over. Additional options, not shown, may include multiple choice questions, true/false, etc. The buyer could also select from a set of pre-defined questions, or choose a subject from which a number of questions will be automatically selected. The buyer could also provide information about the recipient, such as demographic information and personal preferences, to be used in selecting or customizing a pre-determined game.

Depending on the resources available and the flexibility of the game system, the buyer could be given the opportunity to design a completely customized game, defining his own tasks, goals, answers, and the like. The game provider could also offer the services of a game designer who will work with the buyer to design a customized game based on the buyer's input and the designer's expertise. The game provider may allow the buyer or a game designer to upload a data file that defines the game, allowing the game to be created off-line and for games to be exchanged by those who create them. Once the game is configured and is ready to be delivered to the recipient, a unique code or set of codes is generated that identifies both the game and the gift. This code is sent to the recipient, for example, in the form of a URL, so that the recipient can access the game and ultimately receive the gift.

A more complicated game product may allow a buyer to give multiple gifts to multiple recipients, and have the recipients work together, cooperatively or in competition, to complete the games and receive the gifts. A multi-stage game may have some stages which require the recipients to complete sub-games individually, and other stages where the recipients must combine their results from the individual stages. Multiple parties may be able to participate in a game, for example, each of several individuals could provide one round of a multi-round game.

A multi-recipient game may also be set up in which anyone who completes the game receives the gift. This might be used for promoting a new product, building excitement around a product by encouraging people to solve the game in an attempt to receive a free sample of the product, or even to discover what it is. Alternatively, only the first recipient might receive the gift (or prize, as the case may be). In another example, a teacher may set up a game that encourages her students to learn about a subject in order to obtain some reward.

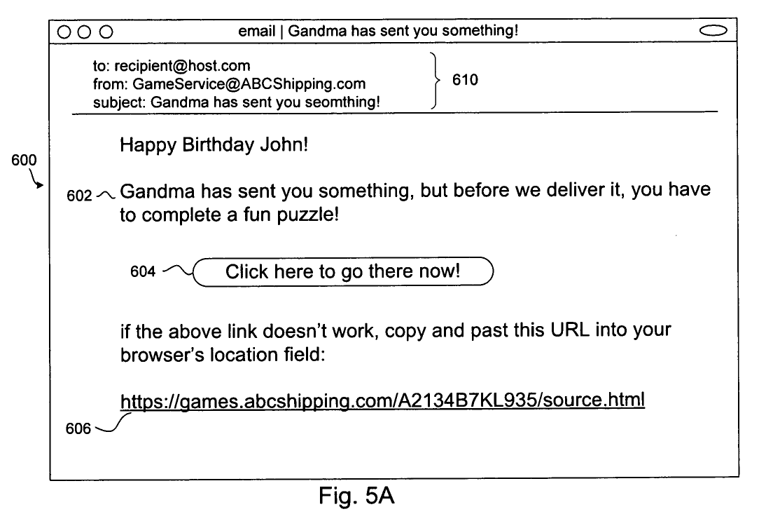

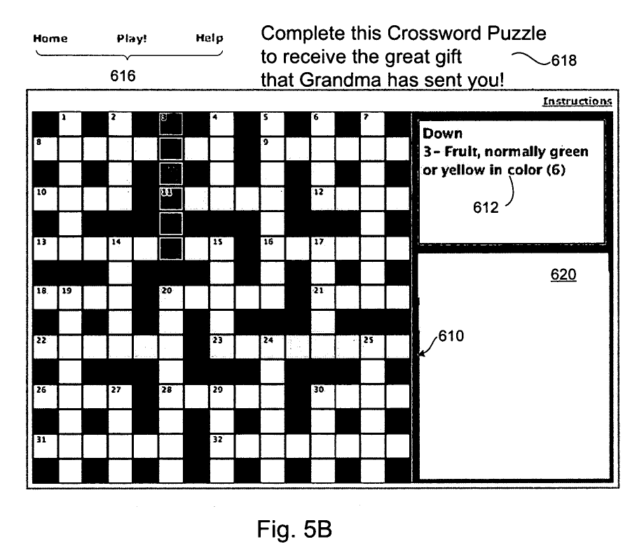

Once the game and gift are ready, the recipient is notified of the game. In some examples, the recipient receives an email like that in FIG. 5A. Email message 600 includes an announcement 602 that the buyer has sent the recipient a gift, and that the recipient must complete a puzzle to receive it. A link 604 takes the recipient directly to the puzzle, while a fallback message 606 provides the puzzle's URL in case the recipient's email program can't follow the link 604. The email headers 610 serve their usual role. When the recipient loads the game, he may be presented with a webpage like that shown in FIG. 5B. A crossword puzzle 610 is presented, with clues 612 listed to the right. A link 614 above loads instructions while other links 616 take the recipient to other parts of the web site. A banner 618 reminds the recipient that he has a gift waiting for him when he completes the puzzle. Empty space 620 may be used for advertising, hints, personal messages from the sender, and other things.

Running the game through an on-line interface provides a number of advantages. The computer system hosting the game can enforce any rules that are set up, limiting response times, and controlling access to information or to future stages of a multi-stage game. In cases where multiple recipients are in competition, the computer system can determine without any uncertainty who was the first to complete a given task. The system can also penalize recipients for wrong answers, for example, preventing a recipient from attempting another answer for some amount of time after a wrong answer, to discourage guessing. The puzzle interface can also provide participants with a means to communicate, such as an instant messaging service or Voice-over-IP. By providing these services, the game provider can keep the recipients on its site, exposed to whatever advertisements or other revenue-building tools the site employs.

The game may also be configured as an offline program that does not require an Internet connection, so that the recipient may complete it at his convenience, or take it with him in a portable device, for example to use during completion of a game that requires discovering things away from the computer. In some examples, brick-and-mortar stores might also provide this service, by providing a computer terminal in-store for buyers or recipients or both to use for their part of the exchange, or by hosting game designers in the store who can manage the entire process for the buyer. In some examples, recipients who otherwise engage the system entirely on-line might choose to pick up their gift in a physical store. This would provide additional marketing opportunities for the seller.

Another consideration is what to do if the recipient never solves the puzzle. Of course one option is not to deliver the gift, but this is generally undesirable from a business standpoint, as it represents a lost sale for the seller and a lost job for the shipper. An alternative is to have a default time after which the gift will be delivered regardless of whether the puzzle was solved, or after which the gift is redirected to the buyer to do with as he pleases. Another alternative is for the completion of the puzzle to unlock features of the gift, but not be a criteria for receipt of the gift itself. Options about what to do in this situation may be presented to the buyer and customized based on the particular situation.

The service being provided by the game increases interaction between the buyer and the recipient, especially in cases where the buyer customizes the game. This makes gift-giving more rewarding, putting a more personal touch on the gift and, in the cases of highly customized games, encouraging the recipients to, for example, learn more about, or simply work with, their families.

The system could be extended to enhance other e-commerce applications, for example, instead of providing a game, the system could require the recipient to deposit payment for the item in escrow or directly with the sender and authorize delivery when the recipient provides proof of that payment.

In some examples, a customer of a shipper could arrange for delivery of an item directly from the customer to the recipient based on the working of the puzzle or game without involvement of a merchant.

Other embodiments are within the scope of the following claims.

What is claimed is:

1. A method comprising
in response to information provided by a first user, enabling a second user to engage at least partly electronically in an interactive activity that is based on the information provided by the first user,
determining that the second user has engaged in the interactive activity, and
providing an item comprising a product or service of interest to the second user, the item being paid for at least partially by the first user.

2. The method of claim 1 in which providing the item comprises delivering the item.

3. The method of claim 1 also comprising enabling the item to be obtained by online interaction with an online entity.

4. The method of claim 1 in which the item is received from the first user.

5. The method of claim 1 in which providing the item includes steps of delivery of the item to the second user, and at least one of the steps of the delivery occurs before determining that the second user has engaged in the interactive activity.

6. The method of claim 1 in which providing the item includes informing the second user that the item is available for pick-up at a location.

7. The method of claim 1 also comprising receiving identifications of the first user and the second user from a seller of the item.

8. The method of claim 1 also comprising receiving an identification of the interactive activity from the first user.

9. The method of claim 8 also comprising receiving an identification of the interactive activity from two or more first users.

10. The method of claim 8 also comprising receiving a data file that defines the interactive activity from the first user.

11. The method of claim 1 also comprising receiving instructions from the first user to automatically select the interactive activity.

12. The method of claim 1 also comprising receiving identification from the first user of a date when the second user should be enabled to engage in the interactive activity.

13. The method of claim 1 in which the enabling of the second user to engage in the interactive activity is facilitated by a seller of the item.

14. The method of claim 1 in which the enabling of the second user to engage in the interactive activity includes informing the second user that the interactive activity is available.

15. The method of claim 1 in which the providing includes delivery of the item by a shipper to the second user and the enabling of the second user to engage in the interactive activity is done by the shipper.

16. The method of claim 1 also including enabling the first user to control selection of the item.

17. The method of claim 1 in which providing the item comprises delivering the item to a shipper with instructions.

18. The method of claim 17 also comprising
instructing the shipper not to deliver the item until a condition is met.

19. The method of claim 18 in which the condition comprises the second user having engaged in the interactive activity.

20. The method of claim 1 in which providing the item comprises enabling the second user to download the item.

21. The method of claim 1 in which providing the item comprises enabling the second user to use the item.

22. The method of claim 1 in which enabling the second user to engage in the interactive activity includes presenting advertising to the second user.

23. The method of claim 1 in which enabling the second user to engage in the interactive activity includes at least one of communicating a URL to the second user, serving a web page to the second user, downloading software to the second user, receiving information from the second user, and presenting to the second user one or more of a user interface of the interactive activity, advertisements, an identification of a seller of the item, an identification of a shipper, decorations selected by a seller of the item, and decorations selected by a shipper of items.

24. The method of claim 23 in which the advertisements advertise one or more of accessories for the item, upgrades to the item, services related to the item, and additional items complementary to the item.

25. The method of claim 23 in which the decorations comprise trade dress of the seller or the shipper.

26. The method of claim 23 in which the information received from the second user comprises proof that the second user has paid a sum of money.

27. The method of claim 1 in which the item comprises one or more of a tangible asset, a negotiable instrument, an electronic equivalent of a negotiable instrument, a privilege, the right to use a service, an item of value, information, an identification of a location of another item of interest, and data.

28. The method of claim 1 in which the interactive experience comprises one or more of a puzzle, a crossword puzzle, a sudoku puzzle, a word-search puzzle, an electronic representation of a board game, a quiz, a game, a trivia game, a scavenger hunt, and a series of interactive experiences.

29. The method of claim 1 also including enabling the first user to select one or more of a type of interactive activity from a set of types of interactive activities, a specific interactive activity from a set of specific interactive activities, a difficulty, and a theme.

30. The method of claim 1 also including enabling the first user to control one or more of a theme, information to be used in the interactive activity, problems to be posed by the interactivity, solutions to problems to be posed by the interactivity, and data representing the interactivity.

31. The method of claim 1 also including enabling the first user online to cause the the interactive activity to be custom designed.

32. The method of claim 1 in which enabling the second user comprises one or more of presenting the interactive experience to the second user, receiving input from the second user, updating the state of the interactive experience, evaluating whether the input is responsive to the interactive experience, and determining that the second user has completed the interactive experience.

33. A system comprising one or more computers configured to
allow a first user to purchase an item,
provide a first user interface to allow the first user to select an interactive activity,
provide a second user interface to allow a second user to engage in the interactive activity,
determine that the second user has completed participating in the interactive activity, and
cause the delivery of the item when the second user has completed participating.

34. A method comprising
receiving an item of value to be delivered to a recipient, and
in response to a confirmation that a puzzle has been solved at least in part by the recipient, delivering the item to the recipient.

35. A method comprising
enabling a giver to buy a gift on line for a recipient and to control the provision of a puzzle for the recipient to solve before the gift is to be delivered, and
causing the gift to be delivered only under circumstances related to the solving of the puzzle.

36. A package comprising
packaging,
a gift inside the packaging, and
a label identifying the package as one not to be delivered to a recipient until a shipper of the package has received confirmation that a game associated with delivery has been solved by the recipient.
